(19) United States
(12) Patent Application Publication
(10) Pub. No.: US 2026/0061311 A1
(43) Pub. Date: Mar. 5, 2026

(54) PREDICTIVE FRAME GENERATION FOR LATENCY REDUCTION

(71) Applicant: ZING5G COMMUNICATIONS CANADA INC., Aurora (CA)

(72) Inventor: Ian Chappell, Aurora (CA)

(21) Appl. No.: 18/861,455

(22) PCT Filed: Aug. 29, 2024
(86) PCT No.: PCT/IB2024/058423

§ 371 Date: Oct. 29, 2024

(51) Int. Cl. A63F 13/52; H04L 9/32

(52) U.S. Cl. CPC A63F 13/52; H04L 9/3236

(57) ABSTRACT

An example method includes: detecting a first input state; generating a state descriptor representing the first input state and sending the state descriptor to a server; receiving, from the server, a set of frames representing a corresponding set of predicted subsequent states and storing the set of frames in a local repository; detecting a second input state; and matching the second input state to one of the predicted subsequent states and retrieving a corresponding subsequent frame from the set of frames in the local repository, the corresponding subsequent frame representing the second input state.

### FIELD

The specification relates generally to latency reduction for an interactive program, and more particularly to predictive frame generation for an interactive program.

### BACKGROUND

Interactive programs such as video games have visual frames which vary and can be affected by user input. When the logic for generating the visual frames is performed at a remote server and streamed to a local device, the time required to render the visual frames based on the user input may cause latency between the input time and the display of the corresponding visual frame.

### SUMMARY

According to an aspect of the present specification an example method includes: detecting a first input state; generating a state descriptor representing the first input state and sending the state descriptor to a server; receiving, from the server, a set of frames representing a corresponding set of predicted subsequent states and storing the set of frames in a local repository; detecting a second input state; and matching the second input state to one of the predicted subsequent states and retrieving a corresponding subsequent frame from the set of frames in the local repository, the corresponding subsequent frame representing the second input state.

According to another aspect of the present specification, another example method includes: receiving a state descriptor representing a first input state at a client device; determining a set of predicted subsequent states based on the first input state; obtaining a set of frames, each frame representing one of the predicted subsequent states; sending the set of frames to the client device to select one of the frames from the set for presentation in response to a second input state corresponding to one of the predicted subsequent states.

According to another aspect of the present specification, an example device includes: a memory having a repository for storing frames; a communications interface; and a processor interconnected with the memory and the communications interface, the controller configured to: detect a first input state; generate a state descriptor representing the first input state and send the state descriptor to a server; receive, from the server, a set of frames representing a corresponding set of predicted subsequent states and store the set of frames in the repository; detect a second input state; and match the second input state to one of the predicted subsequent states and retrieve a corresponding subsequent frame from the set of frames in the local repository, the corresponding subsequent frame representing the second input state.

According to another aspect of the present specification, an example server includes: a memory and a communications interface; a processor interconnected with the memory and the communications interface, the processor configured to: receive a state descriptor representing a first input state at a client device; determine a set of predicted subsequent states based on the first input state; obtain a set of frames, each frame representing one of the predicted subsequent states; send the set of frames to the client device to select one of the frames from the set for presentation in response to a second input state corresponding to one of the predicted subsequent states.

### BRIEF DESCRIPTION OF DRAWINGS

Implementations are described with reference to the following figures, in which:

FIG. 1 depicts a schematic diagram of an example system for predictive frame generation for latency reduction.

FIG. 2 depicts block diagrams of certain internal components of the server and the client device of FIG. 1.

FIG. 3 depicts a flowchart of an example method of provisioning an interactive program supported by predictive frame generation.

FIG. 4 depicts a flowchart of an example method of predictive frame generation.

FIG. 5 depicts a schematic diagram of predictive frame generation.

FIG. 6 depicts a schematic flow diagram of predictive frame generation.

### DETAILED DESCRIPTION

Cloud computing, and particularly provisioning of interactive programs such as games, may be subject to latency issues. Predictions of user inputs at the server may still be subject to transmission delays.

In accordance with the present disclosure, the system may reduce transmission delay by both predicting subsequent states, rendering said states, and transmitting frames representing said states to the local client device for storage. In particular, the predicted subsequent states may cover likely alternative options for subsequent states, as well as a buffer period of subsequent states and frames. The frames for each of these options may be stored locally at the client device for retrieval of the suitable matching state. The system may therefore reduce latency by storing potential options at the local device. The server may then continually predict subsequent states to maintain the buffer period.

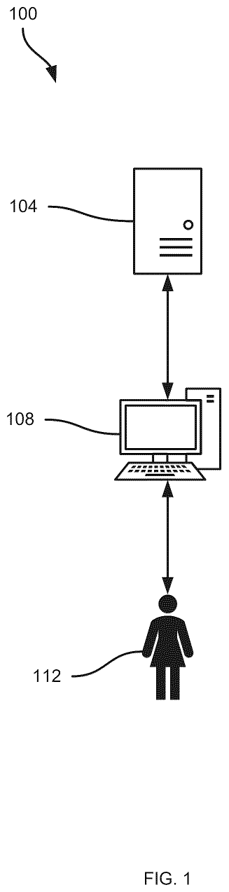

FIG. 1 depicts a system 100 for predictive frame generation for latency reduction. The system 100 includes a server 104 in communication with a client device 108 operated by a user 112. In accordance with the present disclosure, the system 100, and more particularly, the server 104, is generally configured to configured to predict states and proactively generate frames representing the predicted states in accordance with the present disclosure. In particular, the frames generated by the server 104 may be stored at a local repository at the client device 108 to reduce latency in displaying the frames at the client device 108 to the user 112.

Accordingly, the server 104 is generally configured to analyze input states from the client device 108 and predict a set of subsequent states. The server 104 may additionally generate and/or otherwise obtain (e.g., via retrieval from memory), frames representing the predicted subsequent states and send the frames to the client device 108. The server 104 may be any suitable server environment, including a series of cooperating servers, one or more cloud-based servers, and the like. The internal components of the server 104 will be described in greater detail below.

The client device 108 may be a suitable computing device configured to provision an interactive program or application for the user 112. For example, the interactive program may be a video game, an interactive show or the like. Accordingly, the client device 108 may be a fixed or mobile computing device such as a laptop computer, a desktop computer, a mobile phone or the like, configured to provision a game or other interactive program. In other examples, the client device 108 may be a dedicated game console or similar. The internal components of the client device 108 will also be described in greater detail below.

In operation, the system 100 is generally configured to use an input state to predict one or more future or subsequent states. For example, the input state may represent a current state of a video game according to inputs received from the user 112 at an input device for the client device 108. That is, if the user 112 is providing input to the client device 108 to enable an action within the game, then the input state may encode the specific inputs received at the client device 108. In some examples, the input state may additionally include the game context and user account profile parameters. Other parameters affecting the input state are also contemplated. The server 104 may then use the predicted subsequent states to generate corresponding frames representing each of the subsequent states.

The corresponding frames representing each of the predicted subsequent states may be locally cached at the client device 108, such that when an actual subsequent state is detected at the client device 108 which matches one of the predicted subsequent states, the corresponding video frame may simply be loaded from a repository in which the frames are locally cached, rather than actively rendering the state and/or waiting for the frame to be retrieved from a server or other remote repository, or the like. The predictive frame generation and local storage of the predicted frames may therefore lower the latency of the interactive program and the overall latency of the system 100.

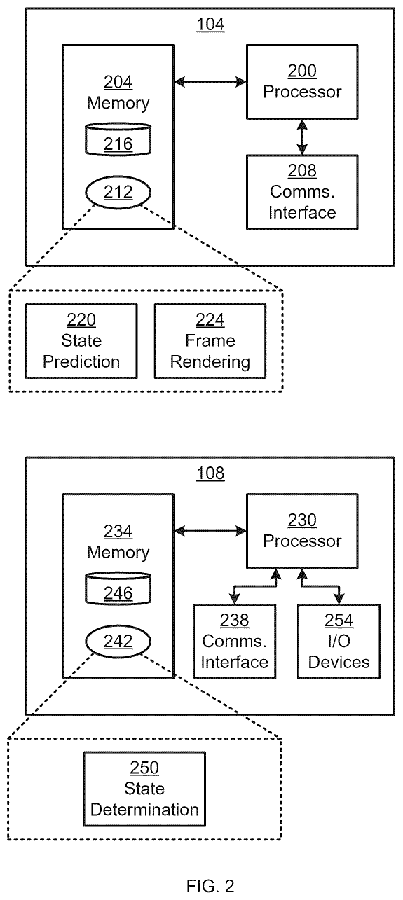

Turning now to FIG. 2, certain internal components of the server 104 are depicted in greater detail. The server 104 includes a processor 200, a memory 204 and a communications interface 208.

The processor 200 may include a central processing unit (CPU), a microcontroller, a microprocessor, a processing core, a field-programmable gate array (FPGA), or other similar device capable of executing machine-readable instructions. The processor 200 may include multiple cooperating processors. The processor 200 may cooperate with the memory 204 to realize the functionality described herein.

The memory 204 may include a combination of volatile (e.g., Random Access Memory or RAM) and non-volatile memory (e.g., read-only memory or ROM, Electrically Erasable Programmable Read Only Memory or EEPROM, flash memory). All or some of the memory 204 may be integrated with the processor 200. The memory stores applications, each including a plurality of computer-readable instructions executable by the processor 200. The execution of the instructions by the processor 200 configures the server 104 to perform the actions discussed herein. In particular, the applications stored in the memory 204 include a predictive frame provisioning application 212. When executed by the processor 200, the application 212 configures the processor 200 to perform various functions discussed below in greater detail and related to the predictive frame provisioning operation of the server 104.

The memory 204 may also store a repository 216 storing data for the predictive frame provisioning operation. For example, the repository 216 may store various input states together with one or more subsequent predicted states, and one or more frames corresponding to or representing each subsequent predicted state. That is, for a given input state, the server 104 may identify a plurality of potential subsequent states, with each potential subsequent state being associated with a probability score representing the probability of occurrence. The association between the input state and the each of the potential subsequent states may be tracked in the repository 216. Additionally, each potential subsequent state may have a frame representing a visual representation of the state. The frame may additionally be stored in the repository 216 in association with the subsequent state. In particular, the frame may be stored in the repository 216 in an encoded representation suitable for transmission to the client device 108.

The application 212 includes a state prediction module 220 and a frame rendering module 224. The state prediction module 220 is configured to determine the set of predicted states for a given input states. In some examples, the state prediction module 220 may be configured to reference the repository 216 to determine if the given input state has one or more stored predicted states with which it is associated. In other examples, the state prediction module 220 may apply a predictive model to the input state to determine the predicted states associated with the input state. For example, the predictive model may include one or more machine learning-based algorithms, neural networks, or the like, while in other examples, the predictive model may be a deterministic model. The frame rendering module 224 is configured to render the frames representing the predicted states. For example, the frame rendering module 224 may render the frames according to state parameters of the predicted state (e.g., expected input parameters for the predicted state), as well as program parameters of the interactive program (e.g., actions and/or events resulting from the expected input parameters).

In other examples, the application 212 may also be implemented as a suite of distinct applications. Further, some or all of the functionality of the application 212 may be implemented as dedicated hardware components, such as one or more FPGAs or application-specific integrated circuits (ASICs) or the like.

The server 104 further includes the communications interface 208 interconnected with the processor 200. The communications interface 208 may be configured for wireless (e.g., satellite, radio frequency, Bluetooth, Wi-Fi, or other suitable communications protocols) or wired communications and may include suitable hardware (e.g., transmitters, receivers, network interface controllers, and the like) to allow the server 104 to communicate with other computing devices, such as the client device 108. The specific components of the communications interface 208 are selected based on the types of communication links that the server 104 communicates over.

The server 104 may further include one or more input and/or output devices (not shown). The input devices may include one or more buttons, keypads, touch-sensitive display screen, mice, or the like for receiving input from an operator. The output devices may include one or more display screens, monitors, speakers, sound generators, vibrators, or the like for providing output or feedback to an operator.

FIG. 2 further illustrates certain internal components of the client device 108 in greater detail. The client device 108 similarly includes a processor 230, a memory 234, and a communications interface 238.

The processor 230 may be a CPU, a microcontroller, a microprocessor, a processing core, an FPGA, or other similar device capable of executing machine-readable instructions. The processor 230 may include multiple cooperating processors. The processor 230 may cooperate with the memory 234 to realize the functionality described herein.

The memory 234 may include a combination of volatile and non-volatile memory. All or some of the memory 234 may be integrated with the processor 230. The memory 234 stores applications, each including a plurality of computer-readable instructions executable by the processor 230. The execution of the instructions by the processor 230 configures the device 108 to perform the actions discussed herein. In particular, the applications stored in the memory 234 include an interactive program application 242 configured to implement the interactive program for interaction from the user 112. For example, the application 242 may be a game application for a video game.

The memory 234 may further store a repository 246 for storing data for the interactive program. Some or all of the repository 246 may be integrated or associated with the application 242. For example, the repository 246 may act as a local cache for the frames corresponding to the potential predicted subsequent states.

The application 242 is generally configured to implement the interactive program and may include instructions for the implementation and execution of the program, including responses to user inputs at the client device 108 and the like. The application 242 may additionally include a state determination module 250 configured to determine a current state of the interactive program. In particular, the state determination module 250 may be configured to detect (i) intrinsic data about the interactive program, such as a game identifier, a level identifier within the game, difficulty settings, the presence and number of non-player characters, the resolution and/or other graphical parameters, and the like; (ii) input data from the user 112 to the client device 108; and (iii) user data or parameters, representing characteristics about the user 112, such as a play style (e.g., level of aggressiveness or caution displayed), reaction time, and the like. The state determination module 250 may be configured to output a state descriptor representing the detected state. For example, the state descriptor may be a string (e.g., a hash value generated via a hash function based on each of the detected parameters), an array of data values, or other suitable representations encoding (preferably uniquely or substantially uniquely) the detected parameters.

In other examples, the application 242 may also be implemented as a suite of distinct applications. Further, some or all of the application 242 may be implemented as dedicated hardware components, such as one or more FPGAs or ASICs or the like.

The device 108 further includes the communications interface 238 interconnected with the processor 230. The communications interface 238 may be configured for wireless (e.g., satellite, radio frequency, Bluetooth, Wi-Fi, or other suitable communications protocols) or wired communications and may include suitable hardware (e.g., transmitters, receivers, network interface controllers, and the like) to allow the device 108 to communicate with other computing devices, such as the server 104. The specific components of the communications interface 238 are selected based on the types of communication links that the device 108 communicates over.

The device 108 may further include one or more input and/or output devices 254. The input devices may include one or more buttons, keypads, touch-sensitive display screens, mice, game controllers, joysticks, or the like for receiving input from the user 112. The output devices may include one or more display screens, monitors, speakers, sound generators, vibrators, or the like for providing output or feedback to the user 112.

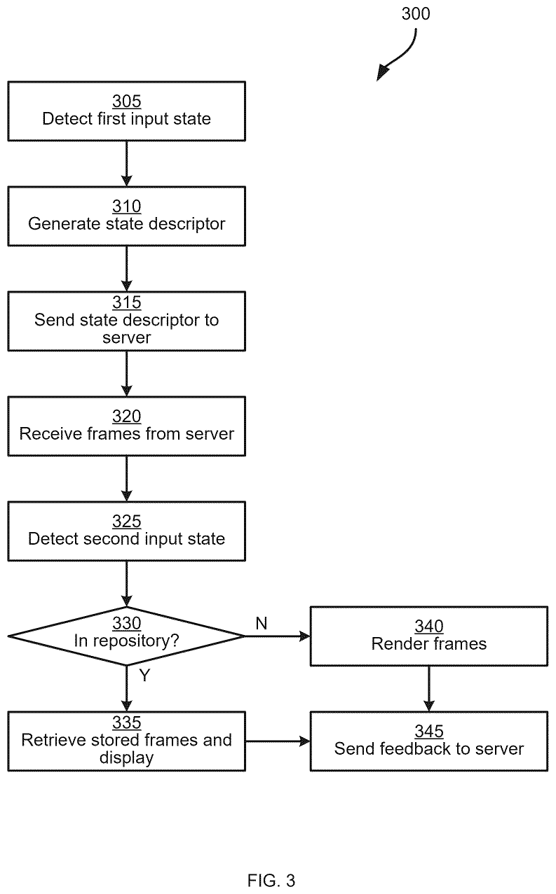

Turning now to FIG. 3, the functionality implemented by the client device 108 will be discussed in greater detail. FIG. 3 illustrates a method 300 of implementing an interactive application with predictive frame generation. The method 300 will be discussed in conjunction with its performance in the system 100, and particularly by the device 108, via execution of the application 242. In particular, the method 300 will be described with reference to the components of FIGS. 1 and 2. In other examples, the method 300 may be performed by other suitable devices or systems.

At block 305, the client device 108 is configured to detect a first input state of the interactive program. Generally, the input state may represent the inputs and game state for a time frame over which the user 112 is capable of providing a new input.

In particular, the client device 108 may detect user inputs from the input devices 254, such as a physical input on a game controller by the user 112. For example, the physical input may be the depression of one or more buttons of the game controller and/or a movement of a joystick or touchpad or the like. For example, the physical inputs to the input device 254 may correspond to movements and/or actions within the game context (e.g., jumping, kicking, accelerating, or the like, according to the game context). The client device 108 may additionally identify or detect intrinsic game context parameters such as a level and/or difficulty of the game, a location and/or field of view in the environment of the game context, and the like. In particular, the input state may therefore include indicators of the game state and inputs which may directly affect and contribute to the subsequent states of the game.

The client device 108 may additionally detect user parameters based on the user profile, for example as detected based on game play, or as previously detected and stored in association with the user profile. The user parameters may include reaction time, play style, and the like. In particular, the input speed and reaction time may vary between users 112 (e.g., according to the users' experience or the like), and hence such personalized user parameters may affect possible subsequent states. Accordingly, the input state may further be influenced by the detected user parameters.

At block 310, the client device 108 is configured to generate a state descriptor representing the input state detected at block 305. For example, the state descriptor may be a hash value (i.e., a string) generated by applying a hash function to the parameters describing the input state. In other examples, the state descriptor may include an array including the parameters describing the input state, a combination of the above, or other suitable representations. In particular, the state descriptor may encode the parameters of the input state, such that each state descriptor uniquely or substantially uniquely describes the input state (e.g., by applying a hash function for which collisions are rare).

At block 315, the client device 108 is configured to send the state descriptor generated at block 310 to the server 104 for processing to allow the server 104 to determine and/or predict potential subsequent states.

In particular, the state descriptor may allow the server 104 to generate a set of frames for each of the predicted potential subsequent states and send the frames to the client device 108 to be stored locally at the client device 108. Accordingly, substantially simultaneously as any or all of the blocks 305 to 315, the client device 108 may retrieve locally stored frames corresponding to the first input state, for example from the repository 246. Since each input state may represent a period of time over which the user 112 is capable of providing inputs, and the frame processing rate may be faster than such a time period, each input state may be represented by more than one frame. Further, in some examples, certain inputs may result in actions which take a predefined amount of time, and which cannot be further affected (or may be minimally affected) by additional inputs before the actions are complete. Accordingly, such input states may be represented by frames rendering the completed action.

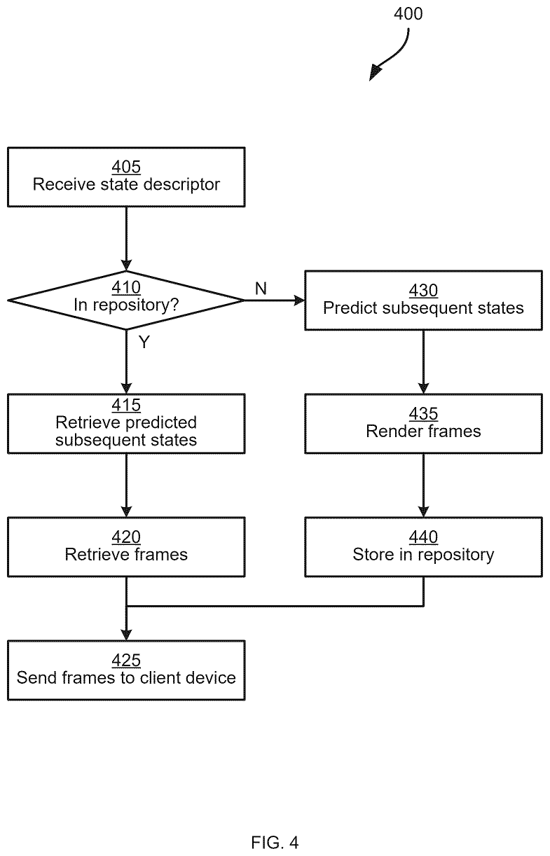

Referring now to FIG. 4, the functionality implemented by the server 104 will be discussed in greater detail. FIG. 4 illustrates a method 400 of predictive frame generation to support an interactive application at a client device. The method 400 will be discussed in conjunction with its performance in the system 100, and particularly by the server 104, via execution of the application 212. In particular, the method 400 will be described with reference to the components of FIGS. 1 and 2. In other examples, the method 400 may be performed by other suitable devices and systems.

At block 405, the server 104 receives the state descriptor from the client device 108. For example, the state descriptor may be generated at block 310 of the method 300 and may be representative of the first input state detected at block 305 of the method 300. The state descriptor may generally be used to determine one or more predicted subsequent states based on the first input state.

In particular, at block 410, the server 104 may be configured to determine whether the state descriptor is stored in the repository 216. In particular, the repository 216 may store state descriptors which have previously been encountered, and for which the potential subsequent states have previously been predicted and corresponding frames generated. Accordingly, the repository 216 may allow the state prediction and frame generation operation to be performed only once at an initial occurrence.

If the determination at block 410 is affirmative, that is, the state descriptor already exists in the repository 216, then the server 104 proceeds to block 415. At block 415, the server 104 is configured to retrieve the predicted subsequent states associated with the input state (i.e., associated with the state descriptor) from the repository 216. In some examples, the server 104 may additionally apply one or more filtering operations to the predicted subsequent states stored in the repository 216 to retrieve the predicted subsequent states which satisfy a threshold condition. For example, the threshold condition may include a threshold probability or confidence, and hence the server 104 may retrieve the predicted subsequent states which have a probability or confidence level above the threshold value. In other examples, the server 104 may select a predefined number of predicted subsequent states, selected in rank order according to the probability or confidence level of each predicted subsequent state. In still further examples, the server 104 may not apply any filtering operation, and may simply retrieve all of the associated predicted subsequent states in the repository 216.

At block 420, the server 104 is configured to retrieve the frames associated with each of the predicted subsequent states identified at block 415. In particular, the repository 216 may additionally store the frames, or encoded versions thereof which are suitable for transmission in association with each predicted subsequent state. Each predicted subsequent state may similarly represent a period over which an input may be received and/or a period over which an indicated action is carried out. Accordingly, each predicted state may include a plurality of frames representing the period and in accordance with the frame rate of the program.

At block 425, the server 104 is configured to send the frames retrieved at block 420 to the client device 108. The frames may be sent to the client device 108 with other identifying information, such as the corresponding predicted subsequent state (e.g., as identified via a state descriptor for the predicted subsequent state), a sequence and/or relative timestamp within a sequence of frames, and the like, to allow the client device 108 to select the appropriate frames as will be described further below.

If, at block 410, the determination is negative, that is, the state descriptor and/or the input state corresponding to the state descriptor is not stored in the repository 216, then the server 104 proceeds to block 430. In particular, if the state descriptor is not stored in the repository 216, the server 104 may determine that the particular combination of game context, user context and inputs have not yet been encountered, and hence the server 104 has not yet analyzed the combination to determine likely outcomes or subsequent states. Accordingly, at block 430, the server 104 is configured to predict one or more subsequent states based on the input state defined by the state descriptor received at block 405.

In particular, the server 104 may apply a predictive model to predict the subsequent states. For example, the server 104 may first extract the game context and/or parameters, the user context and/or parameters, and the inputs contributing to the state descriptor. The parameters defining the input state and contributing to the state descriptor may then be input to the predictive model to allow the predictive model to analyze the parameters to generate the predicted subsequent states. For example, the predictive model may apply machine and/or deep learning algorithms, suitable layers of neural networks, and the like.

In particular, to predict the subsequent states, the server 104 may generally apply at least three layers of analysis to facilitate the prediction of the potential subsequent states. In some examples, the layers may be substantially deterministic filters, while in other examples, the layers may be integrated with the machine-learning based predictive model.

The first layer may include a determination of physical limitations, for example based on human limitations or constraints on the input device 254. For example, a subsequent state or states representing a sequence of inputs by the user 112 within a time period that is less than an average time to enter the number of differing inputs in the sequence may be assigned a lower probability of occurrence, according to the difference between the allocated time period and the average time. The first layer may similarly apply logic to apply suitable probabilities to combinations of inputs which are impossible or unlikely based on the physical constraints of the input device 254. For example, if the input device 254 is or includes a joystick, combinations of inputs which include simultaneous opposing movements of the joystick (e.g., moving the joystick both up and down simultaneously) may be assigned a zero probability. The screening rules of the first layer may be predetermined and deterministic, or the screening rules may be interpreted by the predictive model (e.g., to be learned by a deep learning algorithm or neural network).

The second layer may incorporate probabilities of various potential subsequent states according to the game context and/or parameters. For example, the second layer may apply select statistically likely subsequent inputs and/or reactions based on the current state of the game and context. If the game context lays out a predefined path which the user 112 may follow, then the second layer may assume that a subsequent input contributing to a potential subsequent state may substantially correspond with the predefined path. The second layer may additionally account for computer-driven actions, including the relative attributes of non-player characters and the like. The second layer may additionally be implemented by the predictive model trained on historical user actions within specific game contexts. In particular, different games, game types, levels, and the like may contribute to different likelihoods for different input states and predicted subsequent states.

The third layer may incorporate probabilities based on individual player behavior, according to physiological limitations and individual play style, reaction time, or other parameters affecting the speed and types of inputs provided by the user 112.

Accordingly, the predictive model may be trained on historical state sequences, including game context, user context, and user inputs. In particular, the training dataset for the predictive model may preferably include differentiation between game contexts, input methodologies and the like, to sensitize the predictive model to such parameters of the input state.

After applying the layers of analysis, for example by applying the predictive model, the server 104 may identify possible subsequent states and corresponding probabilities (e.g., of occurrence) and/or confidence levels of occurrence as determined by the predictive model, or other suitable metric for the subsequent states. The server 104 may apply a threshold to the subsequent states to identify the subsequent states having at least the threshold metric (e.g., at least 75%, at least 90%, etc.) as being predicted. In other examples, the server 104 may apply other metrics or manners of selecting certain potential subsequent states as being predicted.

At block 435, the server 104 is configured to render a set of frames corresponding to each of the predicted subsequent states from block 430. In particular, the server 104 may apply the game context and inputs associated with the predicted subsequent states (i.e., the inputs and game context which result in the predicted subsequent state) to render the frames as prescribed by the game application and rules. Since each state may represent a period of time over which multiple frames may be generated to satisfy the frame rate of the game application, the server 104 may generate the multiple frames to satisfy the frame rate and to cover the time period corresponding to the predicted subsequent state. The server 104 may further encode each frame to a transmissible format, for example for transmission to the client device 108.

At block 440, the server 104 is configured to store the subsequent states predicted at block 430 together with the frames (or encoded frames) rendered at block 435 in association with the state descriptor received at block 405 in the repository 216. The server 104 may additionally compute the state descriptor for each of the predicted subsequent states and store the state descriptor. In some example, each subsequent state may additionally be stored in association with a probability or confidence level of the predictive model.

The server 104 may the proceed to block 425 to send the frames or encoded frames rendered at block 435 to the client device 108. The newly encoded and rendered frames may similarly be sent to the client device 108 with identifying information to allow the client device 108 to select the appropriate frames for display.

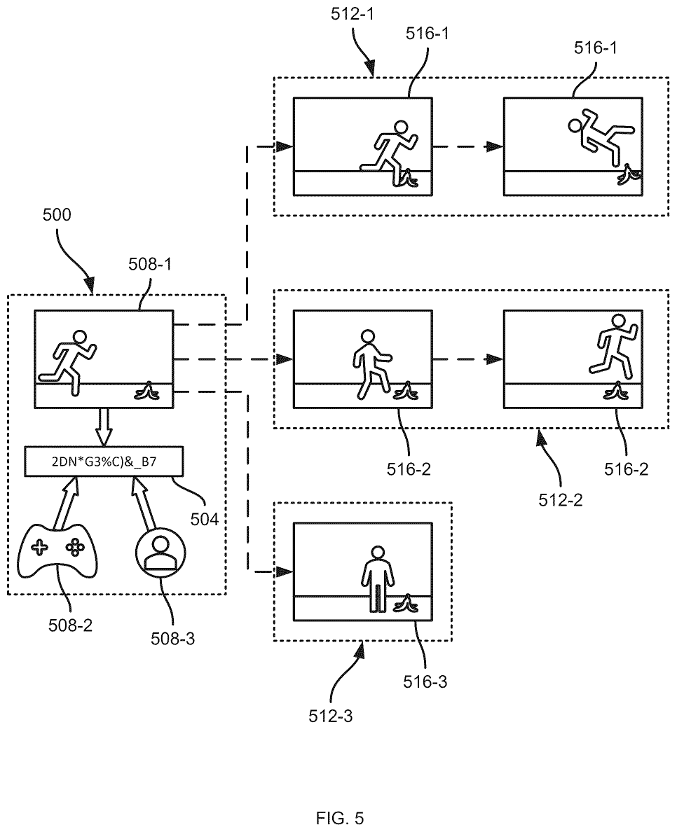

Referring to FIG. 5, a schematic diagram of predictive frame generation is depicted. In particular, during the execution of a game application, an input state 500 may be detected at the client device 108. The client device 108 may generate, at block 310, a state descriptor 504. In particular, the state descriptor 504 may encode contributions representing the game context 508-1, user inputs 508-2, and user context 508-3 (referred to collectively as parameters 508). In the present example, the game context 508-1 may include the location of a character in the game along a path having an obstacle thereon. The inputs 508-2 may include the depression of a movement button, to enable movement of the character along the path. The user context 508-3 may include metrics pertaining to the user's reaction time or the like. The client device 108 may send the state descriptor 504, illustrated in the present example as being a string, to the server 104.

The server 104, in turn, may receive the state descriptor 504 and identify three predicted subsequent states, 512-1, 512-2, and 512-3 (referred to generically as a predicted subsequent state 512 and collectively as the predicted subsequent states 512). In particular, the server 104 may predict that the user 112 may continue providing input indicating movement into the obstacle in the predicted subsequent state 512-1, that the user 112 may provide an input indicating a jump over the obstacle in the predicted subsequent state 512-2, or that the user 112 may terminate input to terminate movement prior to the obstacle in the predicted subsequent state 512-3. In the predicted states 512-1 and 512-2, the inputs provided may result in certain actions or events, which may have corresponding frames, and hence the server 104 may render and encode a plurality of frames 516-1 representing the predicted subsequent state 512-1, a plurality of frames 516-2 representing the predicted subsequent state 512-2, and a single frame (or a reduced set or number of frames) 516-3 representing the predicted subsequent state 512-3. The server 104 may then send the frames 516 to the client device 108 for storage in the repository 246.

In other examples, different parameters 508 may affect the state descriptor 504 and accordingly the predicted subsequent states 512 and/or the probabilities of occurrence of each of the predicted subsequent states 512. For example, if the user context 508-3 indicates an aggressive play style and a quick reaction time, then the probability of the predicted subsequent state 512-2 may be higher, while the probabilities of the predicted subsequent states 512-1 and 512-3 may be lower. In contrast, if the user context 508-3 indicates a cautious play style, the predicted subsequent state 512-3 may be higher. Similarly, the game context 508-1 may also affect the state descriptor 504 and the probabilities of the predicted subsequent states 512. For example, if the game context 508-1 indicates that the floor is slippery, then the probability of the predicted subsequent state 512-1 may be higher, since the user 112 may be less likely to have a sufficient reaction time to provide or remove input for the predicted subsequent states 512-2 and 512-3.

In each of the above examples, if the probabilities of occurrence of a given predicted subsequent state 512 drop below a threshold level, then the server 104 may omit the frames 516 corresponding to the predicted subsequent state 512 from transmission to the client device 108. For example, the server 104 may only identify some of the subsequent states 512 as predicted for storage in the repository 216 in association with the input state 500. This may allow the server 104 to conserve resources and reduce the amount of transmission to the client device 108. That is, the transmissions from the server 104 to the client device 108 are optimized for predicted subsequent states 512 which have at least a threshold probability of occurrence, and hence which have a higher likelihood that the corresponding frames 516 will be applied at the client device 108.

In still further examples, some subsequent states may include a series or sequence of predicted subsequent states. For example, for the predicted subsequent state 512-2, the user 112 may continue or repeatedly input the jump action, resulting in a long or extended jump, while in other examples, the user 112 may input only a single jump action. Additionally or alternatively, in other examples, each of the frames 516-1 depicted in the predicted subsequent state 512-1 may be defined as a separate state 512, rather than a single state 512 including multiple frames 516. In some examples, the server 104 may additionally present or include the additional subsequent states in the series for rendering and encoding.

Returning to FIG. 3, at block 320, the client device 108 is configured to receive the rendered and encoded frames from the server 104. In particular, the frames may be received with identifying information, such as the state descriptor for each frame, a relative timestamp or sequence, and the like. The client device 108 may store the received frames locally in the repository 246 together with the state descriptor for the frame, as well as any sequencing or other identifying information (e.g., if the predicted subsequent state includes multiple representative frames).

At block 325, the client device 108 is configured to detect a second input state of the interactive program. For example, the client device 108 may detect new inputs at the input devices 254, or may simply detect the inputs (e.g., including the same input) over a subsequent input time period (e.g., as computed based on an average human input speed), together with the updated game or program context as determined in response to the previous input window. The client device 108 may additionally generate a second state descriptor for the second input state. Further, detection of the second input state may trigger another iteration through the method 300, with the second input state acting as the first input state of the subsequent iteration.

At block 330, the client device 108 references the second input state detected at block 325 against the repository 246. For example, the client device 108 may search for the second state descriptor representing the second input state within the repository 246. Since the repository 246 stores the frames generated according to predicted subsequent states with high probability, it is likely that the second input state may match one of the predicted subsequent states. Accordingly if, at block 330, the client device 108 matches the second input state to a stored predicted subsequent state from the repository 246, then the client device 108 proceeds to block 335.

At block 335, the client device 108 retrieves the frames corresponding to the second input state from the repository 246 and displays the frames at the client device 108. In particular, the retrieval of the corresponding frames from the local repository 246 may be a faster operation than rendering the frame, and hence may reduce latency between detecting an input state and displaying the corresponding frame.

If the determination at block 335 is negative, that is, the second input state is not detected in the repository 246, then the client device 108 proceeds to block 340 to render the frame representing the second input state. For example, the render may occur at the client device 108, or the client device 108 may transmit the second input state to the server 104 to render the frames and transmit the rendered frames back to the client device 108 for display.

At block 345, after performance of either blocks 335 or blocks 340, the client device 108 may send the second input state (or the second state descriptor thereof) to the server 104 as an actual subsequent state to feedback for additional reinforcement learning of the predictive model. That is, the predictive model at the server 104 may receive the actual subsequent state from the client device 108 and may use the first input state and the actual subsequent state to reinforce the predictive model. For example, the server 104 may apply a deep learning reinforcement algorithm to the actual subsequent state to improve the probability predictions and/or confidence levels of each of the predicted potential subsequent states.

As will be appreciated, the method 400 to predictively generate frames at the server 104 may take some time, and hence may not be able to be completed to store a local copy of the frames for the immediate subsequent state prior to occurrence of the subsequent state. Accordingly, the predicted subsequent states identified by the server 104 may include a series of predicted subsequent states for at least a predefined buffer period (e.g., 1 second, 5 seconds, etc.). That is, the predicted subsequent states and the corresponding frames may cover the buffer period after the first input state. For example, the predefined buffer period may vary based on the storage capacity of the repository 246 at the local client device 108, the network speed and quality of the communication link between the client device 108 and the server 104 or other relevant parameters. For example, the predefined buffer period may be defined based on a test ping from the device 108 to the server 104 and/or may include an additional predefined number of frames and/or coverage for a predefined number of input windows or the like.

The longer the buffer period, the more potential subsequent states may be possible, since each interim input state may generate additional subsequent states. Accordingly, the threshold values to identify subsequent states as predicted states may be lowered based on the distance (i.e., time) from the input state.

Further, since the number of subsequent states may increase significantly according to the buffer period, the client device 108 may periodically purge frames from the local repository 246. For example, after the client device 108 detects a second input state, and displays the corresponding frames from the repository, the client device 108 may remove those frames, and any frames corresponding to another predicted alternative to the second input state (e.g., another state which would have occurred at the time of the second input state had a different input been provided by the user). The client device 108 may use relative timestamps and/or sequencing, state descriptors or other identifying information to identify such unnecessary frames. In other examples, the client device 108 may simply store each frame for at least the buffer period, and discard the frames after the buffer period is complete.

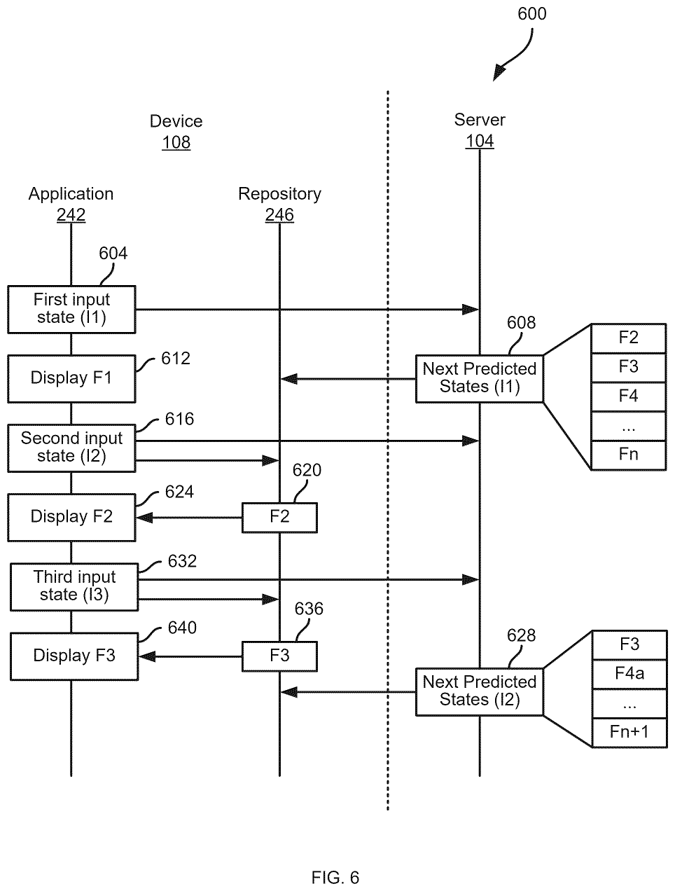

Referring to FIG. 6, a schematic diagram of an example flow 600 of predictive frame generation is depicted. At operation 604, the application 242 detects a first input state 11 and sends the first input state 11 to the server 104. The server 104 may then identify the next predicted states for 11 at operation 608. In particular, the next predicted states may include F2 (corresponding to the immediate subsequent frame input window relative to 11), F3 (corresponding to the frame input window subsequent to F2), F4, and so on until Fn, where n corresponds to the buffer size of frame input windows. Each of the frame sets Fx corresponding to the x-th frame input window may include multiple frames for the frame input window, as well as multiple potential predicted states for the x-th frame input window. The frames for the next predicted states may be retrieved from the repository 216 or rendered by the frame rendering module 224. The server 104 may then send the frames for the next predicted states to the device 108 to be stored at the repository 246.

In the interim, in response to the first input state, the device 108 displays a first frame F1 representing the first input state at operation 612. At operation 616, the device 108 detects a second input state 12 and sends the second input state 12 to the server 104. Simultaneously, in response to detecting the second input state 12, the application 242 may reference the repository 246 to determine whether a frame corresponding to the second input state 12 is stored in the repository 246. In particular, at operation 620, the device 108 may identify the frame (or set of frames, or subset of frames in) F2 stored in the repository 246 and return the appropriate frame(s) of F2 to be displayed at operation 624.

In response to receiving the second input state 12 from the device 108, the server 104 may identify the next predicted states for 12 at operation 628. In particular, the next predicted states may include F3 (for example, being the same as the previously predicted F3, as predicted from 11), F4a (for example including some additional or alternate predicted states based on the second input state 12), and so on until Fn+1. The server 104 may send the frames for the next predicted states for 12 to be stored in the repository 246. In some examples, the server 104 may track frames which overlap from previously sent frames (e.g., F3 at operation 608) and may send only newly identified predicted frames to reduce the amount of data and frames transmitted.

In some examples, the operation 628 of identifying and generating or retrieving the frames for the next predicted states for 12 may take some time, and in the meantime, the application 242 may detect a third input state 13 at operation 632. The device 108 may send the third input state 13 to the server 104 to identify next predicted states (not shown). The device 108 may additionally reference the repository 246 to determine whether a frame corresponding to the third input state 13 is stored in the repository 246. In particular, even though the next predicted states based on 12 may not yet be received, the next predicted states from 11 may have a buffer of n input frame windows, including frames F3 corresponding to the third frame input window. Therefore, at operation 636, the device 108 may identify the frame(s) F3 stored in the repository 246 and return the frame(s) F3 to be displayed at operation 640.

As described herein, a system is provided with predictive frame generation to reduce latency of the system. In particular, a client device may detect an input state and send a state descriptor for the input state to a server for the predictive frame generation. The server identifies predicted subsequent states, including one or more alternative predictive states (e.g., based on different predicted inputs), as well as a sequence of predicted states for each alternative (e.g., to cover a buffer period of predicted subsequent states). The server may additionally render or retrieve frames representing each of the predicted subsequent states and send the frames to the local device.

Accordingly, the client device may locally store the frames representing each predicted subsequent state having above a threshold probability of occurrence (e.g., the top 3 most likely subsequent states, or covering the top 70% of likely subsequent states), over the buffer period. Thus, when the client device detects the actual subsequent state, it is likely (i.e., based on the probability of occurrence) that the actual subsequent state will match one of the predicted subsequent states, and hence the frames representing the actual subsequent state may simply be retrieved from the local repository for display, rather than waiting for them to be rendered.

The system may further be supported by machine-learning based models for the subsequent state prediction. The model may be provided with feedback for continual reinforcement training and learning based on the actual subsequent states.

The scope of the claims should not be limited by the embodiments set forth in the above examples but should be given the broadest interpretation consistent with the description as a whole.

1. A method at a client device, the method comprising:
detecting a first input state;
generating a state descriptor representing the first input state and sending the state descriptor to a server;
receiving, from the server, a set of frames representing a corresponding set of predicted subsequent states and storing the set of frames in a local repository;
detecting a second input state; and
matching the second input state to one of the predicted subsequent states and retrieving a corresponding subsequent frame from the set of frames in the local repository, the corresponding subsequent frame representing the second input state.

2. The method of claim 1, wherein the state descriptor of the first input state is generated based on one or more of: user input at an input device of the client device; program parameters; and account parameters.

3. The method of claim 2, comprising generating the state descriptor by applying a hash function to the one or more of the user input, the program parameters and the account parameters.

4. The method of claim 1, further comprising, when the second input state does not match one of the predicted subsequent states, rendering a second frame representing the second input state.

5. The method of claim 1, further comprising retrieving a series of corresponding subsequent frames from the set of frames, the series of corresponding subsequent frames representing the second input state.

6. The method of claim 1, further comprising sending the second input state to the server as an actual subsequent state for reinforcement learning.

7. The method of claim 1, wherein the set of frames cover a buffer period after the first input state.

8. A method at a server, the method comprising:
receiving a state descriptor representing a first input state at a client device;
determining a set of predicted subsequent states based on the first input state;
obtaining a set of frames, each frame representing one of the predicted subsequent states;
sending the set of frames to the client device to select one of the frames from the set for presentation in response to a second input state corresponding to one of the predicted subsequent states.

9. The method of claim 8, wherein determining the set of predicted subsequent states comprises: retrieving, from a repository at the server, the set of predicted subsequent states associated with the first input state.

10. The method of claim 9, wherein obtaining the set of frames comprises: retrieving, from the repository, the set of frames associated with the predicted subsequent states.

11. The method of claim 8, wherein determining the set of predicted subsequent states comprises: applying a predictive model to the first input state, the predictive model trained on historical state sequences.

12. The method of claim 11, wherein obtaining the set of frames comprises: rendering the frames for each of the predicted subsequent states.

13. The method of claim 11, further comprising:
receiving an actual subsequent state; and
reinforcing the predictive model based on the first input state and the actual subsequent state.

14. The method of claim 8, wherein the set of predicted states comprises potential subsequent states meeting at least a threshold metric.

15. The method of claim 14, wherein the threshold metric comprises one or more of: a threshold probability of occurrence; and a threshold number of the potential subsequent states.

16. The method of claim 8, wherein the set of predicted states covers a buffer period after the first input state.

17. A device comprising:
a memory having a repository for storing frames;
a communications interface; and
a processor interconnected with the memory and the communications interface, the controller configured to:
detect a first input state;
generate a state descriptor representing the first input state and send the state descriptor to a server;
receive, from the server, a set of frames representing a corresponding set of predicted subsequent states and store the set of frames in the repository;
detect a second input state; and
match the second input state to one of the predicted subsequent states and retrieve a corresponding subsequent frame from the set of frames in the local repository, the corresponding subsequent frame representing the second input state.

18. The device of claim 17, wherein the state descriptor of the first input state is generated based on one or more of: user input at an input device of the client device; program parameters; and account parameters.

19. The device of claim 18, wherein the processor is configured to generate the state descriptor by applying a hash function to the one or more of the user input, the program parameters and the account parameters.

20. The device of claim 17, wherein the processor further configured to, when the second input state does not match one of the predicted subsequent states, render a second frame representing the second input state.

21. The device of claim 17, wherein the processor further configured to retrieve a series of corresponding subsequent frames from the set of frames, the series of corresponding subsequent frames representing the second input state.

22. The device of claim 17, wherein the processor further configured to send the second input state to the server as an actual subsequent state for reinforcement learning.

23. The device of claim 17, wherein the set of frames cover a buffer period after the first input state.

24. A server comprising:
a memory and a communications interface;
a processor interconnected with the memory and the communications interface, the processor configured to:
receive a state descriptor representing a first input state at a client device;
determine a set of predicted subsequent states based on the first input state;
obtain a set of frames, each frame representing one of the predicted subsequent states;
send the set of frames to the client device to select one of the frames from the set for presentation in response to a second input state corresponding to one of the predicted subsequent states.

25. The server of claim 24, wherein to determine the set of predicted subsequent states, the processor is configured to: retrieve, from a repository stored in the memory, the set of predicted subsequent states associated with the first input state.

26. The server of claim 25, wherein to obtain the set of frames, the processor is configured to: retrieve, from the repository, the set of frames associated with the predicted subsequent states.

27. The server of claim 24, wherein to determine the set of predicted subsequent states the processor is configured to: apply a predictive model to the first input state, the predictive model trained on historical state sequences.

28. The server of claim 27, wherein to obtain the set of frames, the processor is configured to: render the frames for each of the predicted subsequent states.

29. The server of claim 27, wherein the processor is further configured to:
receive an actual subsequent state; and
reinforce the predictive model based on the first input state and the actual subsequent state.

30. The server of claim 24, wherein the set of predicted states comprises potential subsequent states meeting at least a threshold metric.

31. The server of claim 30, wherein the threshold metric comprises one or more of: a threshold probability of occurrence; and a threshold number of the potential subsequent states.

32. The server of claim 24, wherein the set of predicted states covers a buffer period after the first input state.
